(19) United States
(12) Patent Application Publication
(10) Pub. No.: US 2019/0004769 A1
(43) Pub. Date: Jan. 3, 2019

(54) HIGH-SPEED, LOW-LATENCY, AND HIGH ACCURACY ACCUMULATION CIRCUITS OF FLOATING-POINT NUMBERS

(71) Applicant: MEDIATEK INC., Hsin-Chu City (TW)

(72) Inventors: Wen-Chih KAN, Hsin-Chu City (TW); Yung-Sheng CHENG, Hsin-Chu City (TW)

(21) Appl. No.: 16/022,829

(22) Filed: Jun. 29, 2018

Related U.S. Application Data
(60) Provisional application No. 62/527,181, filed on Jun. 30, 2017.

(51) Int. Cl. G06F 7/485; G06F 5/01

(52) U.S. Cl. CPC G06F 7/485; G06F 5/012

(57) ABSTRACT

An accumulation circuit is provided, which comprises 2^{N} first format converters, an adder tree circuit, a feedback adder, and a second format converter. Each of the first format converter converts a floating-point number to a non-floating-point number. The adder tree circuit is arranged in N levels, wherein the i^{th} level has 2^{N-i} non-floating-point adders, the variable i is an integer and ranges from 1 to N, the first level sums up the non-floating-point numbers, each of the rest levels sums up a plurality of outputs from the previous level, and the N^{th} level outputs a current partial sum value. The feedback adder is configured to add a previous accumulation value of the feedback adder and the current partial sum value as an updated accumulation value. The second format converter converts the updated accumulation value to a floating-point accumulation value in a floating-point format.

This application claims the benefit of U.S. Provisional Application Ser. No. 62/527,181 filed on Jun. 30, 2017, which are hereby incorporated by reference in its entirety.

### CROSS-REFERENCES TO RELATED APPLICATIONS

Not applicable.

### BACKGROUND OF THE INVENTION

### Field of the Invention

The present invention relates to high-speed, low-latency, and high accuracy accumulation circuits of floating-point numbers. More particularly, the present invention relates to accumulation circuits that sum up floating-point numbers by non-floating-point adders for vector processors used in many applications.

### Descriptions of the Related Art

In the digital world, a number may be represented by a fixed-point format or a floating-point format. A floating-point format is defined as having three fields, including a sign, a significand (or called “mantissa”), and an exponent. With these fields, a floating-point format provides a higher dynamic range than a fixed-point format in terms of representing a number.

Addition of two floating-point numbers is achieved by two steps. The first step is to align the floating-point number having a smaller exponent with the floating-point number having a larger exponent by shifting the significand bits of the floating-point number having the smaller exponent. The second step is to sum up the significand bits after the two floating-point numbers have been aligned. Since lower-order bits less than machine epsilon will be rounded off, there will be relative error. The relative error is pronounced when summing up a number that is much greater than the other (e.g. when a first number has an exponent larger than a second number by more than the number of significand bits, the summation of the two numbers would be the first number. It means that the second number cannot be summed up). The relative error is also pronounced when summing up a long sequence of floating point numbers (e.g. a summation of a big number followed by 1000 of smaller numbers). Some floating-point software algorithm sorts the floating-point numbers from least to greatest and then sums them up to increase the accuracy. However, sorting consumes extra time and perhaps more hardware circuitry and/or more program instructions.

Yet another problem of summing up a long sequence of floating point numbers is that a complicated feedback circuit is required. FIG. 1 illustrates an example of a conventional floating-point accumulation circuit 1 for accumulating a sequence of floating-point numbers I₀, I₁, I₂, I₃, I₄, I₅, I₆, I₇, . . . that are inputted continuously. The floating-point accumulation circuit 1 comprises an adder tree circuit 11 and a feedback circuit 13. In this example, the adder tree circuit 11 has 7 floating-point adders arranged in three levels. A floating-point adder is a complicated circuit that has a long datapath. Hence, to speed up the operations of the floating-point accumulation circuit 1, each floating-point adder is designed with multiple pipeline stages (e.g. two pipeline stages as shown in FIG. 1). As each floating-point adder has multiple pipeline stages (e.g. two pipeline stages as shown in FIG. 1), the feedback circuit 13 must have multiple floating-point adders (e.g. two floating-point adders as shown in FIG. 1) and a delay circuit D to achieve accurate accumulation (i.e. previous partial sum value is fed-back to add with current partial sum value).

Therefore, a high-speed, low-latency, and high accuracy accumulation circuit of floating-point numbers is desired in today's vector processors.

### SUMMARY OF THE INVENTION

To solve the aforementioned problems, the present invention provides an accumulation circuit, which comprises 2^{N} first format converters, an adder-tree circuit, a feedback adder, and a second format converter. The parameter N is a positive integer. Each of the first format converter converts a floating-point number to a non-floating-point number. The adder-tree circuit is arranged in N levels, wherein the i^{th} level has 2^{N-i} non-floating-point adders, and the variable i is an integer and ranges from 1 to N. The 2^{N-j} non-floating point adders of the first-level sum up every two of the 2^{N} non-floating-point numbers and produce 2^{N-j} outputs. The non-floating-point adders in each of the rest levels sum up every two of the outputs from the previous level. The non-floating-point adder in the N^{th} level outputs a current partial sum value, which is a summed value of 2^{N} inputs (i.e. 2^{N} non-floating-point numbers). If the input vector length is longer than 2^{N} (i.e. the input sequence has more than 2^{N} floating-point numbers to be accumulated), the input sequence needs to be broken into batches of 2^{N} numbers except the last batch which may be less than 2^{N} numbers. For those scenarios, there need to be more than one iteration of summing up each batch. The summation of each batch is called ‘partial sum value.’ The feedback adder is designed to sum up a previous accumulation value and the current partial sum value (i.e. the summation of the current 2^{N} non-floating-point numbers) as an updated accumulation value. The second format converter is coupled to the feedback adder and converts the updated accumulation value to a floating-point accumulation value in a floating-point format.

The present invention provides another accumulation circuit, which comprises 2^{N} first format converters, an adder-tree circuit, and a second format converter. The parameter N is a positive integer. Each of the first format converter converts a floating-point number to a non-floating-point number. The adder-tree circuit is arranged in N levels, wherein the i^{th} level has 2^{N-i} non-floating-point adders, and the variable i is an integer and ranges from 1 to N. The non-floating-point adders in the first level sum up every two of the non-floating-point numbers and produce 2^{N-j} outputs. The non-floating-point adders in each of the rest levels sum up every two of the outputs from the previous level. The non-floating-point adder in the N^{th} level outputs an accumulation value. The second format converter converts the accumulation value to a floating-point accumulation value in a floating-point format.

As described in previous paragraphs, an accumulation circuit of the present invention converts the floating-point numbers into the non-floating-point numbers so that the non-floating-point numbers can be accumulated by the non-floating-point adders of the adder-tree circuit. For the accumulation circuit that comprises the feedback adder, the feedback adder further sums up a previous accumulation value and the current partial sum value as an updated accumulation value. The non-floating-point adders of the adder-tree circuit and the feedback adder are all in full-precision. After accumulating all the numbers, the accumulation circuit converts the (updated) accumulation value (which is still a non-floating-point number) to the floating-point format. Non-floating-point adders in this invention are not only full-precision adders but also have simple design and short datapath. Therefore, the floating-point numbers can be accumulated more accurately by shorter pipeline stages.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates an example of a conventional floating-point accumulation circuit 1;

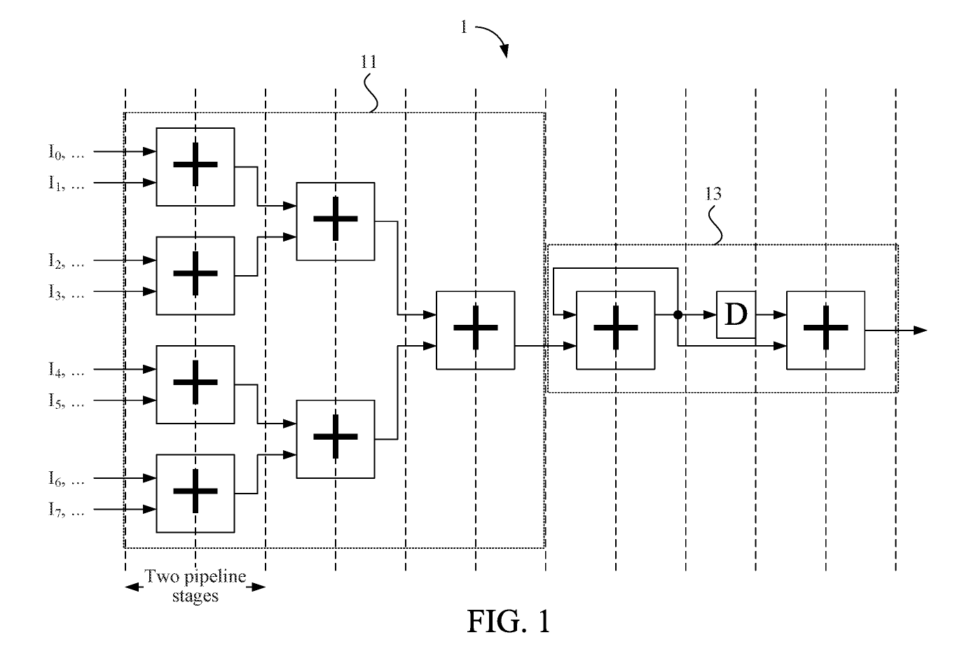

FIG. 2 illustrates the accumulation circuit 2 of the first embodiment; and

FIG. 3 illustrates the accumulation circuit 3 of the second embodiment.

### DESCRIPTION OF THE PREFERRED EMBODIMENT

In the following descriptions, the accumulation circuits of the present invention will be explained with reference to embodiments thereof. However, these embodiments are not intended to limit the present invention to any specific environment, applications, or particular implementations described in these embodiments. Therefore, description of these embodiments is only for purpose of illustration rather than to limit the scope of the present invention. It should be appreciated that, in the following embodiments and the attached drawings, elements unrelated to the present invention are omitted from depiction. In addition, dimensions of and dimensional relationships among individual elements in the attached drawings are provided only for purpose of illustration but not to limit the scope of the present invention.

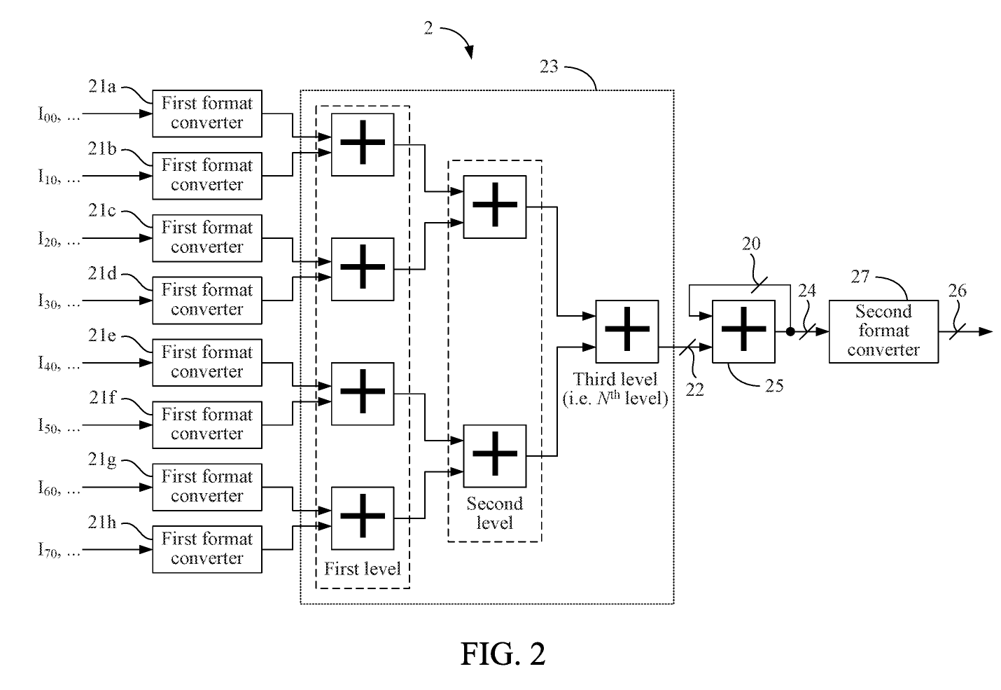

A first embodiment of the present invention is an accumulation circuit 2 for accumulating a sequence of floating-point numbers I₀₀, I₁₀, I₂₀, I₃₀, I₄₀, I₅₀, I₆₀, I₇₀, and a schematic view of which is illustrated in FIG. 2. The accumulation circuit 2 comprises 2^{N} first format converters 21a, 21b, 21c, 21d, 21e, 21f, 21g, 21h, an adder tree circuit 23, a feedback adder 25, and a second format converter 27, wherein the parameter N is 3. Please note that the parameter N may be any positive integer in other embodiments.

The first format converters 21a, 21b, 21c, 21d, 21e, 21f, 21g, 21h are of the same type, and the second format converter 27 is an inverse converter of any of the first format converters 21a, 21b, 21c, 21d, 21e, 21f, 21g, 21h. The adder tree circuit 23 is arranged in N levels, wherein the i^{th} level has 2 non-floating-point adders, and the variable i is an integer and ranges from 1 to N. Each of the non-floating-point adders in the adder tree circuit 23 is full-precision and the feedback adder 25 is also full-precision. The non-floating-point adders of the adder tree circuit 23 and the feedback adder 25 providing full-precision means that throughout the accumulation, there is no sacrifice in accuracy in the accumulated result. They also in general have simple design and short datapath. Hence, the accumulation performed by the accumulation circuit 2 can be achieved by shorter pipeline stages (e.g. they are so high-speed, one pipeline stage can even contain consecutive two levels of the adder tree circuit 23).

As shown in FIG. 2, the inputs of the first level of the adder tree circuit 23 are coupled to the outputs of the first format converters 21a, 21b, 21c, 21d, 21e, 21f, 21g, 21h one-on-one, while the inputs of each of the rest levels of the adder tree circuit 23 are coupled to the output(s) of the corresponding previous level one-on-one (e.g. the inputs of the second level are coupled to the outputs of the first level one-on-one). An input of the feedback adder 25 is coupled to an output of the N^{th} level of the adder tree circuit 23 and another input of the feedback adder 25 is coupled to its output. An input of the second format converter 27 is coupled to the output of the feedback adder 25.

Each of the first format converter 21a, 21b, 21c, 21d, 21e, 21f, 21g, 21h converts a floating-point number to a non-floating-point number. For example, at some instant, the first format converter 21a, 21b, 21c, 21d, 21e, 21f, 21g, 21h convert the floating-point numbers I₀₀, I₁₀, I₂₀, I₃₀, I₄₀, I₅₀, I₆₀, I₇₀ to a plurality of non-floating-point numbers. The first level (i.e. the non-floating-point adders of the first level) of the adder tree circuit 23 sums up every two of the non-floating-point numbers outputted from the first format converters 21a, 21b, 21c, 21d, 21e, 21f, 21g, 21h and derives a plurality of outputs. Each of the rest levels (i.e. the second level to the N^{th} level) of the adder tree circuit 23 sums up the outputs from the corresponding previous level (i.e. the non-floating-point adders in each of the rest levels sums up every two of the outputs from the previous level). For example, the second level of the adder tree circuit 23 sums up the outputs from the first level. The N^{th} level of the adder tree circuit 23 outputs a current partial sum value 22.

If the input vector length is longer than 2^{N} (i.e. the input sequence has more than 2^{N} floating-point numbers to be accumulated), the input sequence needs to be broken into batches of 2^{N} numbers except the last batch which may be less than 2^{N} numbers. For those scenarios, there need to be more than one iteration of summing up each batch. The summation of each batch is called ‘partial sum value.’ The feedback adder 25 sums up a previous accumulation value 20 of the feedback adder 25 and the current partial sum value 22 as an updated accumulation value 24. The second format converter 27 then converts the updated accumulation value 24 to a floating-point accumulation value 26 in a floating-point format.

Please note that the type of the first format converters 21a, 21b, 21c, 21d, 21e, 21f, 21g, 21h, the type of the second format converter 27, and the type of the non-floating-point adders in the adder tree circuit 23 and the feedback adder 25 are related.

In some embodiments, each of the first format converter 21a, 21b, 21c, 21d, 21e, 21f, 21g, 21h converts a floating-point number to a 2's complement number, each of the non-floating-point adders in the adder tree circuit 23 is a 2's complement adder, the feedback adder 25 is a 2's complement adder, and the aforementioned previous accumulation value 20, current partial sum value 22, and updated accumulation value 24 are 2's complement numbers.

In some other embodiments, each of the first format converter 21a, 21b, 21c, 21d, 21e, 21f, 21g, 21h converts a floating-point number to a 1's complement number, each of the non-floating-point adders in the adder tree circuit 23 is a 1's complement adder, the feedback adder 25 is a 1's complement adder, and the aforementioned previous accumulation value 20, current partial sum value 22, and updated accumulation value 24 are 1's complement numbers.

Yet in some other embodiments, each of the first format converter 21a, 21b, 21c, 21d, 21e, 21f, 21g, 21h converts a floating-point number to a negabinary number, each of the non-floating-point adders in the adder tree circuit 23 is a negabinary adder, the feedback adder 25 is a negabinary adder, and the aforementioned previous accumulation value 20, current partial sum value 22, and updated accumulation value 24 are negabinary numbers.

According to the above descriptions, the accumulation circuit 2 converts the sequence of floating-point numbers I₀₀, I₁₀, I₂₀, I₃₀, I₄₀, I₅₀, I₆₀, I₇₀, . . . into the non-floating-point numbers so that the non-floating-point numbers can be accumulated by the non-floating-point adders of the adder tree circuit 23 and the feedback adder 25, which are all full-precision. After accumulating the sequence of floating-point numbers I₀₀, I₁₀, I₂₀, I₃₀, I₄₀, I₅₀, I₆₀, I₇₀, . . . , the accumulation circuit 2 converts the updated accumulation value 24 (which is still a non-floating-point number) to the floating-point accumulation value 26 in a floating-point format. The non-floating-point adders of the adder tree circuit 23 and the feedback adder 25 are all full-precision, and they also have short datapath. Therefore, the sequence of floating-point numbers I₀₀, I₁₀, I₂₀, I₃₀, I₄₀, I₅₀, I₆₀, I₇₀, . . . can be accumulated more accurately by shorter pipeline stages.

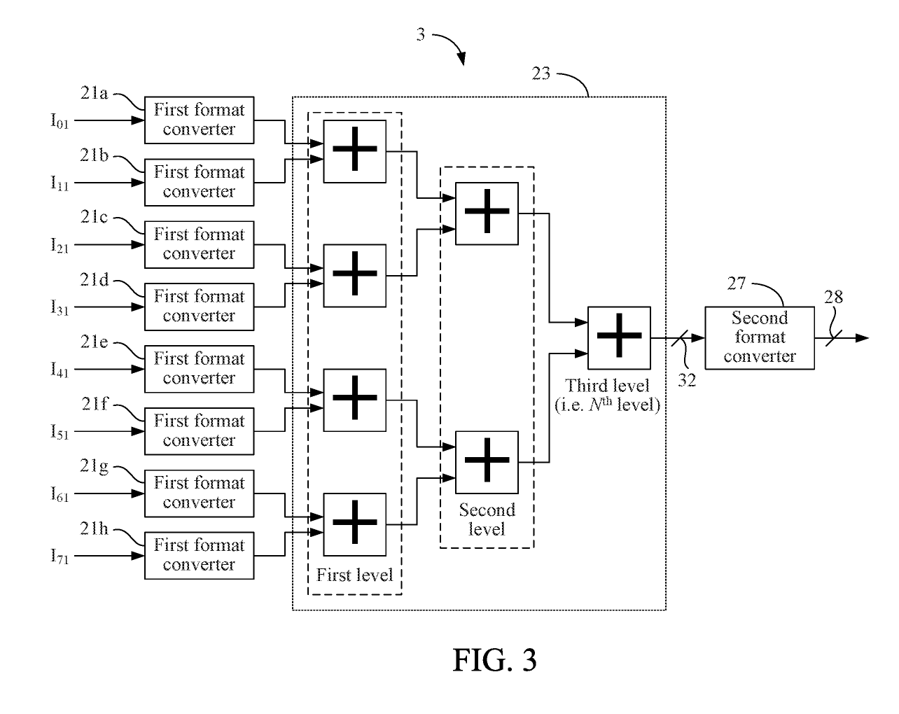

A second embodiment of the present invention is an accumulation circuit 3 for summing up a plurality of floating-point numbers I₀₁, I₁₁, I₂₁, I₃₁, I₄₁, I₅₁, I₆₁, I₇₁ and a schematic view of which is illustrated in FIG. 3. The main difference between the accumulation circuit 3 and the accumulation circuit 2 is that the accumulation circuit 3 does not have the feedback adder 25 coupled to the adder tree circuit 23. The accumulation circuit 3 comprises 2^{N} first format converters 21a, 21b, 21c, 21d, 21e, 21f, 21g, 21h, an adder tree circuit 23, and a second format converter 27, wherein the parameter N is 3. Please note that the parameter N may be any positive integer in other embodiments.

Similar to the first embodiment, the first format converters 21a, 21b, 21c, 21d, 21e, 21f, 21g, 21h are of the same type, and the second format converter 27 is an inverse converter of any of the first format converters 21a, 21b, 21c, 21d, 21e, 21f, 21g, 21h. The adder tree circuit 23 is arranged in N levels, wherein the i^{th} level has 2^{N-i} non-floating-point adders, and the variable i is an integer and ranges from 1 to N. Each of the non-floating-point adders in the adder tree circuit 23 is full-precision. The non-floating-point adders of the adder tree circuit 23 providing full-precision means that throughout the accumulation, there is no sacrifice in accuracy in the accumulated result. They also in general have simple design and have short datapath. Hence, the summation performed by the accumulation circuit 3 can be achieved by shorter pipeline stages (e.g. they are so high-speed, one pipeline stage can even contain consecutive two levels of the adder tree circuit 23).

As shown in FIG. 3, the inputs of the first level of the adder tree circuit 23 are coupled to the outputs of the first format converters 21a, 21b, 21c, 21d, 21e, 21f, 21g, 21h one-on-one, while the inputs of each of the rest levels of the adder tree circuit 23 are coupled to the output(s) of the corresponding previous level one-on-one (e.g. the inputs of the second level are coupled to the outputs of the first level one-on-one). An input of the second format converter 27 is coupled to an output of the N^{th} level of the adder tree circuit 23.

Each of the first format converter 21a, 21b, 21c, 21d, 21e, 21f, 21g, 21h converts a floating-point number to a non-floating-point number. For example, at some instant, the first format converter 21a, 21b, 21c, 21d, 21e, 21f, 21g, 21h convert the floating-point numbers I₀₁, I₁₁, I₂₁, I₃₁, I₄₁, I₅₁, I₆₁, I₇₁ to a plurality of non-floating-point number. The first level (i.e. the non-floating-point adders of the first level) of the adder tree circuit 23 sums up every two of the non-floating-point numbers outputted from the first format converters 21a, 21b, 21c, 21d, 21e, 21f, 21g, 21h and derives a plurality of outputs. Each of the rest levels (i.e. the non-floating-point adders of each of the second level to the N^{th} level) of the adder tree circuit 23 sums up the outputs from the corresponding previous level (i.e. the non-floating-point adders in each of the rest levels sums up every two of the outputs from the previous level), e.g. the second level of the adder tree circuit 23 sums up the outputs from the first level. The N^{th} level of the adder tree circuit 23 outputs an accumulation value 32. The second format converter 27 then converts the accumulation value 32 to a floating-point accumulation value 28 in a floating-point format.

Please note that the type of the first format converters 21a, 21b, 21c, 21d, 21e, 21f, 21g, 21h, the type of the second format converter 27, and the type of the non-floating-point adders in the adder tree circuit 23 are related.

In some embodiments, each of the first format converter 21a, 21b, 21c, 21d, 21e, 21f, 21g, 21h converts a floating-point number to a 2's complement number, each of the non-floating-point adders in the adder tree circuit 23 is a 2's complement adder, and the accumulation value 32 is a 2's complement numbers.

In some other embodiments, each of the first format converter 21a, 21b, 21c, 21d, 21e, 21f, 21g, 21h converts a floating-point number to a 1's complement number, each of the non-floating-point adders in the adder tree circuit 23 is a 1's complement adder, and the accumulation value 32 is a 1's complement numbers.

Yet in some other embodiments, each of the first format converter 21a, 21b, 21c, 21d, 21e, 21f, 21g, 21h converts a floating-point number to a negabinary number, each of the non-floating-point adders in the adder tree circuit 23 is a negabinary adder, and the accumulation value 32 is a negabinary numbers.

According to the above descriptions, the accumulation circuit 3 converts the floating-point numbers I₀₁, I₁₁, I₂₁, I₃₁, I₄₁, I₅₁, I₆₁, I₇₁ to the non-floating-point number so that the non-floating-point numbers can be summed up by the non-floating-point adders of the adder tree circuit 23 which are all full-precision. After summing up the floating-point numbers I₀₁, I₁₁, I₂₁, I₃₁, I₄₁, I₅₁, I₆₁, I₇₁, the accumulation circuit 3 converts the accumulation value 32 (which is still a non-floating-point number) to the floating-point accumulation value 28 in a floating-point format. The non-floating-point adders of the adder tree circuit 23 are all full-precision, and they also have simple design and have short datapath. Therefore, the floating-point numbers I₀₁, I₁₁, I₂₁, I₃₁, I₄₁, I₅₁, I₆₁, I₇₁ can be accumulated more accurately by shorter pipeline stages.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An accumulation circuit, comprising:
2^{N} first format converters, wherein the parameter N is a positive integer and each of the first format converter converts a floating-point number to a non-floating-point number;
an adder tree circuit, being arranged in N levels, wherein the i^{th} level has 2^{N-i} non-floating-point adders, the variable i is an integer and ranges from 1 to N, the non-floating-point adders in the first level sum up every two of the non-floating-point numbers, the non-floating-point adders in each of the rest levels sums up every two of a plurality of outputs from the previous level, and the non-floating-point adder in the N^{th} level outputs a current partial sum value;
a feedback adder, being configured to sum up a previous accumulation value of the feedback adder and the current partial sum value as an updated accumulation value; and
a second format converter, being coupled to the feedback adder and configured to convert the update accumulation value to a floating-point accumulation value in a floating-point format.

2. The accumulation circuit of claim 1, wherein each of the non-floating-point numbers and the current partial sum value is a 2's complement number, and each of the non-floating-point adders and the feedback adder is a 2's complement adder.

3. The accumulation circuit of claim 1, wherein each of the non-floating-point numbers and the current partial sum value is a 1's complement numbers, and each of the non-floating-point adders and the feedback adder is a 1's complement adder.

4. The accumulation circuit of claim 1, wherein each of the non-floating-point numbers and the current partial sum value is a negabinary numbers, and each of the non-floating-point adders and the feedback adder is a negabinary adder.

5. The accumulation circuit of claim 1, wherein each of the non-floating-point adders and the feedback adder is full-precision.

6. An accumulation circuit, comprising:
2^{N} first format converters, wherein the parameter N is a positive integer and each of the first format converter converts a floating-point number to a non-floating-point number;
an adder-tree circuit, being arranged in N levels, wherein the i^{th} level has 2^{N-i} non-floating-point adders, the variable i is an integer and ranges from 1 to N, the non-floating-point adders in the first level sum up every two of the non-floating-point numbers, the non-floating-point adders in each of the rest levels sum up every two of a plurality of outputs from the previous level, and the non-floating-point adder in the N^{th} level outputs an accumulation value; and
a second format converter, being configured to convert the accumulation value to a floating-point accumulation value in a floating-point format.

7. The accumulation circuit of claim 6, wherein each of the non-floating-point numbers and the accumulation value is a 2's complement number, and each of the non-floating-point adders a is a 2's complement adder.

8. The accumulation circuit of claim 6, wherein each of the non-floating-point numbers and the accumulation value is a 1's complement numbers, and each of the non-floating-point adders is a 1's complement adder.

9. The accumulation circuit of claim 6, wherein each of the non-floating-point numbers and the accumulation number is a negabinary numbers, and each of the non-floating-point adders is a negabinary adder.

10. The accumulation circuit of claim 6, wherein each of the non-floating-point adders is full-precision.
